(19) United States
(12) Patent Application Publication
(10) Pub. No.: US 2019/0049480 A1
(43) Pub. Date: Feb. 14, 2019

(54) APPARATUS FOR DETECTING WIND DIRECTION

(71) Applicant: OLFREE, LLC, Poway, CA (US)

(72) Inventors: Robert OLSON, Poway, CA (US); Kyle ADRIANY, San Diego, CA (US); Andy KIEATIWONG, San Diego, CA (US); Philip Charles FREEDMAN, San Diego, CA (US)

(21) Appl. No.: 16/101,293

(22) Filed: Aug. 10, 2018

Related U.S. Application Data
(60) Provisional application No. 62/544,742, filed on Aug. 11, 2017.

(51) Int. Cl. G01P 13/02

(52) U.S. Cl. CPC G01P 13/02

(57) ABSTRACT

An apparatus for detecting wind direction includes an attachment member, an elongated member, a vertical member, and a wind direction indicator. The elongated member extends outward from the attachment member. The vertical member is coupled to the elongated member. The wind indicator is coupled to the vertical member and includes a bottom surface, a top surface opposite the bottom surface, and first and second sides extending from the bottom surface to the top surface. The wind indicator further includes a first fin and a second fin, each extending from the top surface and having a forward portion and an aft portion. A first distance between the respective aft portions of the first and second fins is greater than a second distance between the respective forward portions of the first and second fins such that the first and second fins converge toward one another at an acute angle.

### CROSS-REFERENCE TO RELATED APPLICATION(S)

This application claims priority to U.S. Provisional Application Ser. No. 62/544,742, filed Aug. 11, 2017, which is incorporated herein in its entirety.

### FIELD

This invention relates to wind direction identification devices, and more particularly to an improved wind indicator (vane) used on vessels and on land.

### BACKGROUND

Boats and similar vessels operating on navigable waterways often rely on the direction of wind for propulsion, navigation, and conditions. Wind direction can correspond directly with changing conditions manifesting in wave height and current directions. Monitoring surface currents may be crucial for a wide range of watersport activities from fishing to sailing.

While powered vessels may require constant monitoring of wind direction, wind-propelled vessels, such as sailboats, rely on accurate wind directional information for optimum propulsion. Sails are set and dynamically adjusted based on the real-time changing direction of wind and wind gusts. Misdirection or a lack of dynamic directional data can be catastrophic for a sailboat resulting in slower speeds or capsizing.

Weathervanes have existed to provide a visual indication of the direction of the wind based on their orientation of various flaps. As high-speed winds pass a weathervane, the upper portion provides resistance, such that the upper portion of the weathervane is rotated about a central axis until the resistance is at a minimum. The minimum resistance is physically defined by equal pressures acting on opposite sides of the weathervane. The weathervane thereby indicates a direction based on the adjusting position of the upper portion as it adjusts in direct opposition to the direction of the wind.

When the vane is not pointing into the wind this results in a dramatic increase of drag force, mainly due to an increase in wind-facing cross sectional area. This further results in pressure differentials across the control surfaces of the vane portion. The equilibrium location of the vane corresponds directly to the pointing vector of the vane having the same directional components as the wind direction at that moment. For each wind direction, there exists at least one equilibrium point corresponding to minimal drag forces to which the vane will naturally settle. This results in reduced responsiveness to rapid changes in wind direction and may increase fluttering in turbulent environments.

Traditional weathervanes provide for a singular fin on a static post with a rotational engagement to a shaft or support. While effective to identify the general direction, these traditional weathervanes are susceptible to minor shifts in direction as well as inaccurate readings based on differing pressures on either side of the fin. Further, the inability to provide dynamic adjustment of the weathervane relative to the structure or substrate to which it is attached is extremely limited.

Turbine driven devices using a fan assembly disposed within a tubular member or a plurality of cups disposed around a single central axis are configured to provide more information relating to the speed of wind passing by or through the weathervane. However, these devices are subject to the same limitations described above.

### SUMMARY

In one aspect, a wind indicator includes a bottom surface, a top surface opposite the bottom surface, and first and second sides extending from the bottom surface to the top surface. The wind indicator further includes a first fin and a second fin, each extending from the top surface and having a forward portion and an aft portion. A first distance between the respective aft portions of the first and second fins is greater than a second distance between the respective forward portions of the first and second fins such that the first and second fins converge toward one another at an acute angle.

In another aspect, an apparatus for detecting wind direction includes an attachment member, an elongated member, a vertical member, and a wind direction indicator. The elongated member extends outward from the attachment member. The vertical member is coupled to the elongated member. The wind indicator is coupled to the vertical member and includes a bottom surface, a top surface opposite the bottom surface, and first and second sides extending from the bottom surface to the top surface. The wind indicator further includes a first fin and a second fin, each extending from the top surface and having a forward portion and an aft portion. A first distance between the respective aft portions of the first and second fins is greater than a second distance between the respective forward portions of the first and second fins such that the first and second fins converge toward one another at an acute angle.

In another aspect, an apparatus for detecting wind direction includes an attachment member, an elongated member, a vertical member, a first magnet, a wind indicator, and a second magnet. The elongated member extends outward from the attachment member. The vertical member is coupled to the elongated member. The first magnet is coupled to the vertical member. The wind indicator is coupled to the vertical member such that the wind indicator can rotate about the vertical member and can translate along the vertical member. The second magnet is coupled to the wind indicator. The first magnet is adjacent to the second magnet and the first magnet and the second magnet are arranged with like poles facing one another such that the wind indicator is at least partially supported by the magnetic force between the first magnet and the second magnet.

### BRIEF DESCRIPTION OF THE DRAWINGS

The features and advantages of the embodiments described herein will be more fully disclosed in, or rendered obvious by the following detailed description of the preferred embodiments, which are to be considered together with the accompanying drawings wherein like numbers refer to like parts and further wherein:

FIG. 1 shows a perspective view of an apparatus for detecting wind direction according to one embodiment;

FIG. 2 shows a side cross-sectional view of the apparatus of FIG. 1;

FIG. 3 shows a detailed side cross-sectional view of the apparatus of FIG. 1;

FIG. 4 shows a perspective view of a wind indicator according to one embodiment;

FIG. 5 shows a side view of the wind indicator of FIG. 4;

FIG. 6 shows a top view of the wind indicator of FIG. 4;

FIG. 7 shows a front view of the wind indicator of FIG. 4;

FIG. 8 shows a perspective view of a wind indicator according to another embodiment;

FIG. 9 shows a side view of the wind indicator of FIG. 8;

FIG. 10 shows a front view of the wind indicator of FIG. 8;

FIG. 11 shows a perspective view of an apparatus for detecting wind direction according to another embodiment;

FIG. 12 shows a side cross-sectional view of the apparatus of FIG. 11;

FIG. 13 shows a detailed side cross-sectional view of the apparatus of FIG. 11;

FIG. 14 shows a side view of a locking post according to one embodiment;

FIG. 15 shows a perspective view of the locking post of FIG. 14;

FIG. 16 shows a side view of a retaining seat according to one embodiment;

FIG. 17 shows a perspective view of the retaining seat of FIG. 16; and

FIG. 18 shows a perspective view of an apparatus for detecting wind direction according to another embodiment.

### DETAILED DESCRIPTION

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively or operably connected” is such an attachment, coupling or connection that allows the pertinent structures to operate as intended by virtue of that relationship. In the claims, means-plus-function clauses, if used, are intended to cover the structures described, suggested, or rendered obvious by the written description or drawings for performing the recited function, including not only structural equivalents but also equivalent structures.

The apparatuses and wind indicators described herein are configured to more accurately indicate the direction of the wind. These wind indicators can be used in any appropriate environment, however, they are particularly suited for use on boats, ships, and other watercraft where knowledge of wind direction is critical. As described further herein, the wind indicators include fins extending from the top surface of the wind indicator. The fins converge toward an apex at an acute angle. In use, this geometry causes an area of low pressure to be created between the fins. This results in the wind indicator being more sensitive to changes in wind direction.

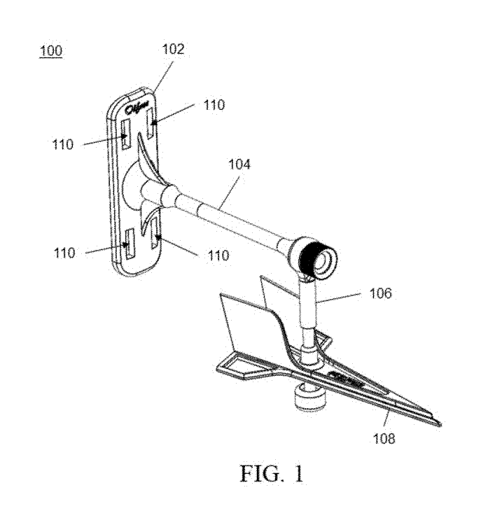

FIGS. 1-3 show a first embodiment of an apparatus 100 for detecting wind direction. As shown in FIG. 1, the apparatus 100 includes an attachment member 102, an elongate member 104, a vertical member 106, and a wind indicator 108.

In an embodiment, the apparatus 100 is attached to a mast of a sailing vessel and positioned such that the wind indicator 108 is visible to an individual or crew working on the deck of the vessel. In such an embodiment, the attachment member 102 is at least partially concave relative to the mast and has one or more apertures extending through the attachment member 102 to facilitate fasteners or other attachment means to extend therethrough and affix the attachment member 102 to the substrate. The attachment member 102 can be attached to the structure in any appropriate manner. For example, as shown in FIG. 1, the attachment member 102 can include one or more apertures 110. In one manner of attachment, a strap, rope, or other member is passed through the apertures 110 to secure the attachment member 102 to the structure. In other embodiments, not shown, the attachment member can be secured to the structure using a fastener (e.g., bolts, screws, or nails) or clamps.

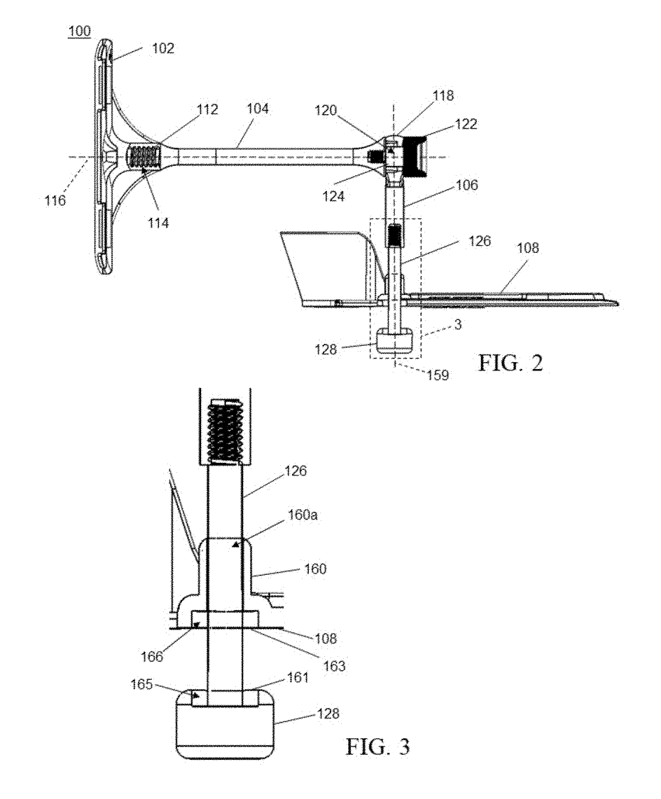

The elongate member 104 extends outward from the attachment member 102. The elongate member 104 can be secured to the attachment member 102 in any appropriate manner. In one embodiment, as shown best in FIG. 2, the elongate member 104 includes an externally threaded extension 112 and the attachment member 102 includes an internally threaded bore 114. The externally threaded extension 112 and the internally threaded bore 114 are configured to engage to secure the elongate member 104 to the attachment member 102. In other embodiments, the elongate member 104 is secured to the attachment member 102 by press-fit, bonding, pins, or other methods. In other embodiments, the elongate member 104 is integrally formed with the attachment member 102.

In another embodiment, the attachment of the elongate member 104 to the attachment member 102 may facilitate rotational or omnidirectional articulation of the elongate member 104 relative to the attachment member 102. The attachment member 102 may provide an opening and the elongate member 104 may have a segment which extends through the opening. The segment extending through the opening may couple to the attachment member 102 through one or more clips acting as a bearing surface contact between the elongate member 104 and the attachment member 102. This gimbal joint may provide for a single pivot joint, a ball-socket, and/or a gyroscopic joint.

The vertical member 106 is coupled to the elongate member 104 and can be coupled in any appropriate manner. As shown in FIGS. 1-3, in one embodiment, the vertical member 106 is configured to rotate about a longitudinal axis 116 of the elongate member 104. This rotation allows the apparatus 100 to accommodate rotation of the craft, particularly roll (i.e., port-starboard rotation). To facilitate rotation, the vertical member 106 can include a rod end 118. The rod end 118 includes a bore 120 through which a portion of a coupler 122 is configured to pass to couple the vertical member 106 to the elongate member 104. In one embodiment, as shown, the coupler 122 is a shoulder bolt having a shoulder 124 that is positioned within the bore 120 of the rod end 118. The coupler 122 also includes a threaded rod configured to engage the elongate member 104. In one embodiment, the rod end 118 is a ball joint type rod end and allows swivel of the vertical member 106 with respect to the elongate member 104.

The vertical member 106 further includes a shaft 126 coupled to the rod end 118. The shaft 126 can be coupled to the rod end 118 in any appropriate manner. For example, as shown, the shaft 126 and the rod end 118 can be coupled by threaded engagement. The wind indicator 108 is coupled to the shaft 126, as will be described further herein. A cap 128 is configured to couple to the shaft 126 to retain the wind indicator 108. The cap 128 can be coupled to the shaft 126 in any appropriate manner (e.g., threaded engagement, bonding, welding, press-fit, etc.). The cap 128 can also serve as a weight to ensure that the vertical member 106 remains in a relatively vertical position.

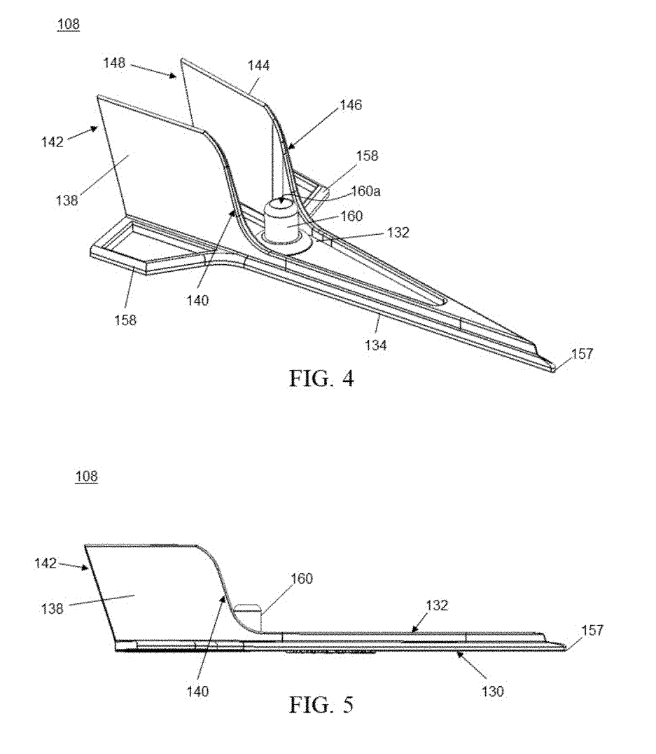

The wind indicator 108 is shown in detail in FIGS. 4-7. The wind indicator 108 includes a bottom surface 130 and a top surface 132. The wind indicator 108 further includes a first side 134 and a second side 136 extending from the bottom surface 130 to the top surface 132. The wind indicator 108 also includes a first fin 138 extending from the top surface 132. The first fin 138 has a forward portion 140 and an aft portion 142. The wind indicator 108 also includes a second fin 144 extending from the top surface 132 and having a forward portion 146 and an aft portion 148. As shown in FIG. 7, a first distance 150 is defined between the aft portion 142 of the first fin 138 and the aft portion 148 of the second fin 144. Additionally, a second distance 152 is defined between the forward portion 140 of the first fin 138 and the forward portion 146 of the second fin 144. The first distance 150 is greater than the second distance 152 such that the first 138 and second 144 fins converge toward one another at an acute angle 154 at an apex 156. The first fin 138 defines a midplane 162 and the second fin 144 defines a midplane 164. In one embodiment, as shown best in FIG. 7, the midplanes 162, 164 are substantially orthogonal to the top surface 132.

In one embodiment, as shown in FIGS. 4-7, the fins 138, 144 are symmetric about a midline of the wind indicator 108. In other embodiments, the fins 138, 144 are arranged such that they are not symmetric about a midline of the wind indicator 108.

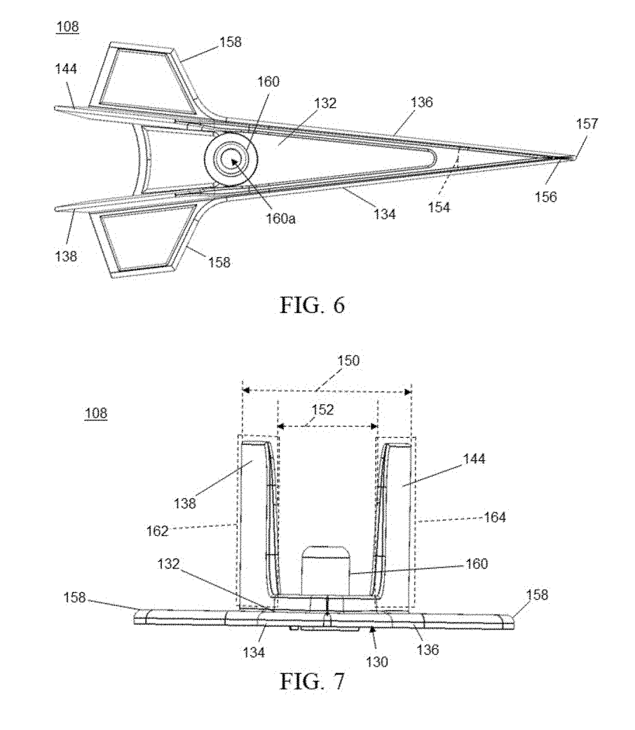

In one embodiment, as shown best in FIG. 6, the first side 134 and the second side 136 converge toward one another at the same acute angle 154 at which the first fin 138 and the second fin 144 converge. The first side 134 and the second side 136 extend away from a vertex 157 between the first 134 and second 136 sides. As a result, the wind indicator 108 is generally V-shaped where the first 134 and second 136 sides share a plane with the vertex 157.

In one embodiment, the wind indicator 108 has a substantially continuous surface area between the bottom surface 130 and the top surface 132. While, in an alternative embodiment, the wind indicator 108 has a plurality of frame extensions provided for structural rigidity and weight reduction. The plurality of frame members may extend across an open area between the bottom surface 130 and the top surface 132. Further, one or more frame members may be added in a coplanar configuration relative to the wind indicator 108, whereby the frame members extend outward from the general sides of the V-shaped wind indicator 108.

In some embodiments, the wind indicator 108 can also include wings 158 extending out horizontally from the first side 134 and the second side 136. The wings 158 can be adjacent to the first 138 and second 144 fins. The wings 158 can be solid or, alternatively can be in the form of an outer frame with an open interior, as shown best in FIGS. 4 and 6.

The wind indicator 108 is mounted to the shaft 126 such that the wind indicator 108 is able to rotate about a longitudinal axis 159 of the vertical member 106. The wind indicator includes an extension 160 extending upward from the top surface 132. A bore 160a extends through the extension 160 and opens to the bottom surface 130. The bore 160a is configured to receive the vertical member 106 therethrough. When in use, wind contacting the fins 138, 144 applies a force to the fins inducing rotation of the wind indicator 108 about the axis 159 (shown in FIG. 2). In one embodiment, as shown in FIG. 5, the fins 138, 144 are positioned posterior to the bore 160a. As a result, the force applied to the fins 138, 144 by the wind results in a torque being applied about the longitudinal axis 159 and, thereby, causes rotation of the wind indicator 108.

When air passes over the wind indicator 108, the two angled fins 138, 144 create a low-pressure pocket between them. This is due to flow separation over the fins 138, 144 which results in turbulent eddies near the aft portions 142, 148 of the fins 138, 144. In an embodiment, the angle of the fins optimizes relative wind pressure on an outside surface and interior void between the two fins. In some embodiments, the angle of the fins is less than 90 degrees. The angle of the fins can be less than 85, 80, 75, 70, 65, 60, 55, 50, 45, 40, 35, 30, 25, 20, 15, 10, or 5 degrees or any angle between the aforementioned angles. The pressure on the exterior surface of each of the fins is generally greater than that within the interior void. As the wind flow passes the fins, the higher pressure along the exterior surfaces travels around a rear perimeter of each of the fins into the low pressure within the interior void. As the relative high pressure areas on the exterior of the fins equalizes, that is where the pressure outside of the first fin and the pressure outside of the second fin tend towards an equilibrium with one another, the vertex is rotated toward an opposite direction of the wind flow, thereby indicating the measured wind direction.

In another embodiment, the aft portions 142, 148 of each of the fins 138, 144 has an irregular geometry or varying angle relative to the top surface 132. For example, the aft portions 142, 148 of each of the fins 138, 144 may continue at an acute angle relative to the top surface 132.

The inventors have surprisingly discovered that the two angled fin wind indicator described herein greatly improves indicator responsiveness and accuracy over traditional vane geometries. This is accomplished in part by taking advantage of tensioned equilibrium. As opposed to a single (straight) fin vane design, the two-fin wind indicator uses the competing drag forces of the two angle fins to increase the restoring force produced in response to shifts in the wind direction. Furthermore, since the wind indicator described herein maintains a low-pressure pocket between the two fins while pointing in the wind direction, wind shifts cause an immediate response in the wind indicator. Additionally, the two-fin design prevents over correction, or spinning as a result of gusts, since it maintains a significant drag force, even while pointing directly into the wind.

In some embodiments, the wind indicator 108 is mounted to the vertical member 106 in a manner that minimizes friction between the components, thereby allowing the wind indicator 108 to respond more accurately to changes in wind direction. For example, in one embodiment, as shown in the cross-sectional view of FIG. 3, the wind indicator is supported at least partially by repulsive magnetic forces. A first magnet 161 is coupled to the vertical member 106. For example, the first magnet 161 can be positioned within a recess 165 of the cap 128. A second magnet 163 is coupled to the wind indicator 108. For example, the second magnet 163 can be positioned within a recess 166 in the wind indicator 108. The first 161 and second 163 magnets can be any appropriate magnets. For example, in one embodiment, the first 161 and second 163 magnets are disc magnets. The first 161 and second 163 magnets are positioned such that like poles of the magnets are facing one another. For example, in one embodiment, the north poles of the magnets are facing one another. In another embodiment, the south poles are facing one another. Because of this arrangement, a repulsive force is present between the magnets. This repulsive force supports the wind indicator 108. Hence, frictional forces are not applied to the top 132 and bottom 130 surfaces of the wind indicator 108. This allows the wind indicator 108 to rotate about the vertical member 106 more freely and, as a result, more accurately respond to changes in wind direction, including small changes. In some embodiments, the magnetics can comprised of NdFeB, Strontium Ferrite, Ceramic (iron oxide and barium/strontium carbonate), Samarium Cobalt, NdFeB, Neodymium, Aluminum, Iron, Cobalt and Nickel (Alnico), Ferric oxide, or a combination thereof. In some embodiments, the magnet can be coated to prevent corrosion. The coating can be Nickel-Copper-Nickel plating, a polymer overcoat, or overmolded when integrated into the windvane.

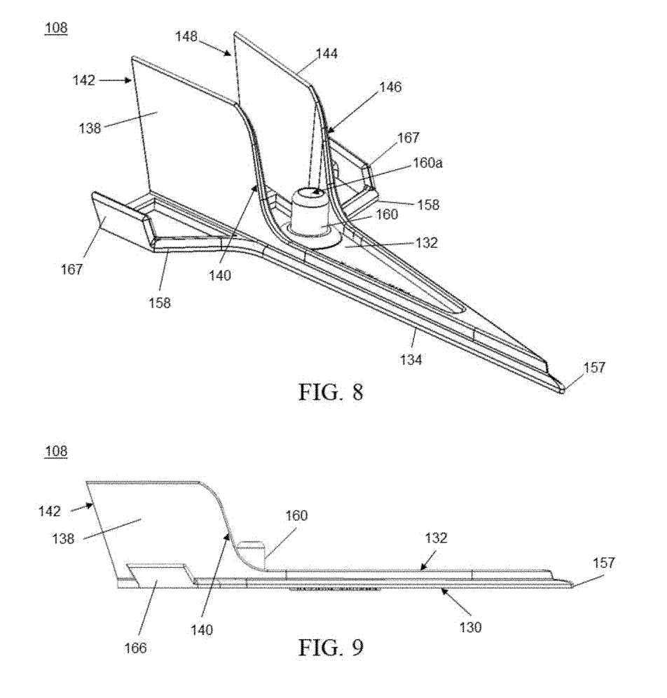

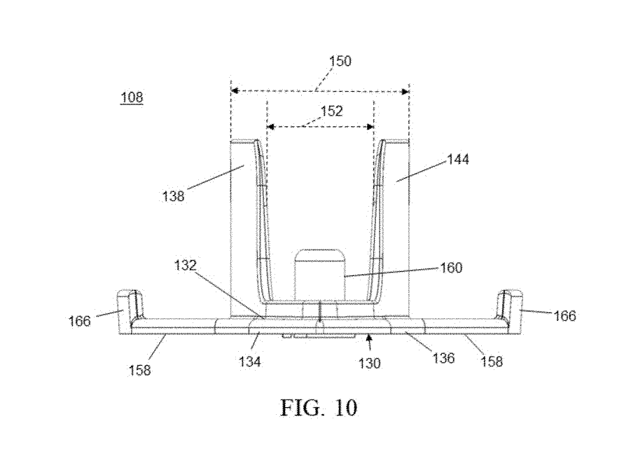

In another embodiment, shown in FIGS. 8-10, the wind indicator 108 further includes winglets 167 attached to the wings 158. As shown in FIG. 10, the winglets 167 can extend upward and substantially parallel to the fins 138, 144.

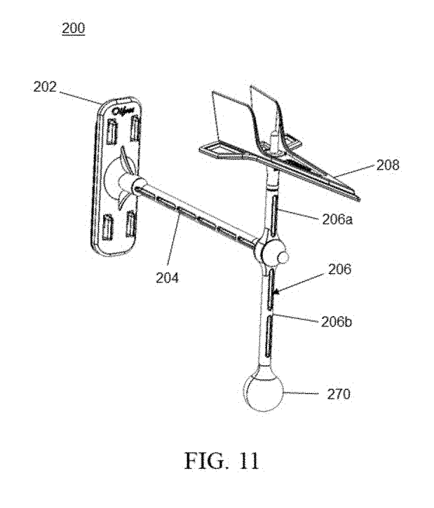

FIGS. 11-13 show another embodiment of an apparatus 200 for detecting the direction of the wind. The apparatus 200 includes an attachment member 202, an elongate member 204, a vertical member 206, and a wind indicator 208. The wind indicator 208 can be substantially similar to the wind indicator 108 described above.

In the apparatus 200, the vertical member 206 includes an upper portion 206a above the elongate member 204 and a lower portion 206b below the elongate member 204. The wind indicator 208 is coupled to the upper portion 206a and a weight 270 is coupled to the lower portion 206b. When mounted to a mast or other structure, gravity acting on the weight 270 causes the vertical member 206 to be in a substantially vertical orientation. In an embodiment, the weight 270 may be releasably engaged to the vertical member 206 such that the weight 270 is selectively replaceable for a particular application or particular weather environment. In another embodiment, the weight 270 is integrally formed with, or fixedly connected to, the vertical member 206.

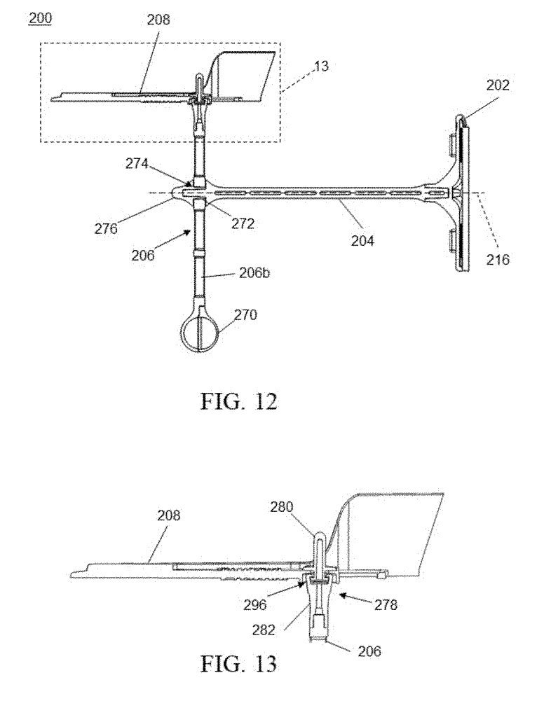

The vertical member 206 is coupled to the elongate member 204 such that the vertical member 206 can rotate with respect to the longitudinal axis 216 of the elongate member. For example, as shown in FIG. 12, the elongate member 204 can include a protrusion 272 that extends through an aperture 274 of the vertical member 206. A retainer 276 can be connected to the end of the protrusion 272 to retain the vertical member 206. The retainer 276 can connect to the protrusion 272 in any appropriate manner, including, for example, threaded engagement, bonding, welding, or a press-fit.

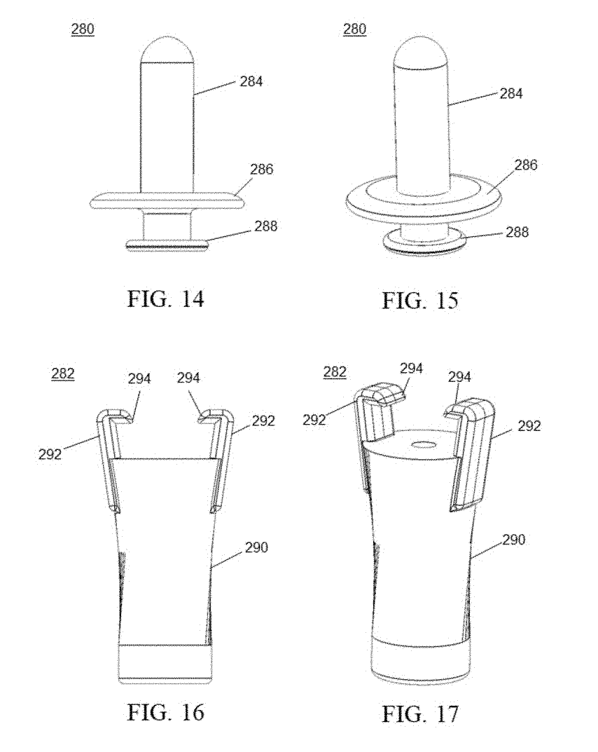

As shown in FIG. 13, the apparatus 200 includes an attachment mechanism 278 for attaching the wind indicator 208 to the vertical member 206. The attachment mechanism 278 facilitates a rotational movement of the wind indicator 208 relative to the vertical member 206. The attachment mechanism 278 includes a locking post 280 and a retaining seat 282. As shown in FIGS. 14 and 15, the locking post includes a post 284 and an upper flange 286 and a lower flange 288, each extending away from the post 284. The lower flange 288 has a smaller diameter than the upper flange 286 such that the lower flange 288 is able to pass through a bore extending through the wind indicator 208.

As shown in FIGS. 16 and 17, the retaining seat 282 includes a body 290 and one or more retaining arms 292 extending from the body 290. The retaining arms 292 include inwardly extending shoulders 294 configured to engage and retain the lower flange 288 of the locking post 280, as will be described further herein. The retaining arms 292 may be configured as flex-arms.

During assembly of the apparatus 200, the retaining seat 282 is mounted to the vertical member 206. The retaining seat 282 can be mounted in any appropriate manner, including threaded engagement, bonding, welding, press-fit, or any other appropriate method. The wind indicator 208 is placed over the retaining seat 282 such that retaining seat 282 is aligned with the bore extending through the wind indicator 208. The wind indicator can include a recess 296 (shown in FIG. 13) into its bottom surface for receiving the retaining seat 282. The lower flange 288 of the locking post 280 is then inserted through the bore until it engages the retaining arms 292 of the retaining seat 282, with the shoulders 294 of the retaining arms engaging and restraining the lower flange 288. In this position, the upper flange 286 of the locking post 280 is in contact with, or adjacent to, the top surface of the wind indicator 208. Hence, the wind indicator 208 is coupled to the vertical member 206.

In another embodiment, any element of the device may be provided with a hollow or solid interior depending on the particular application or desired weight reduction. For example, the vertical member 206 may be provided with a plurality of openings longitudinally along the distance between the attachment mechanism and the weight 270.

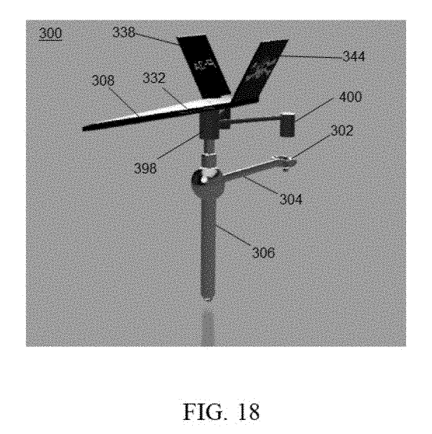

In another embodiment, shown in FIG. 18, an apparatus 300 includes an attachment member 302, an elongate member 304, a vertical member 306, and a wind indicator 308. The apparatus 300 further includes a supplemental directional element 398 mounted to the vertical member 306. The supplemental directional element 398 can provide additional directional information and provide verification of the information provided by the wind indicator 308. The supplemental directional element 398 is coupled to the vertical member 306 such that the supplemental directional element 398 can rotate about the vertical member 306.

As shown in FIG. 18, the first fin 338 and the second fin 344 of the wind indicator 308 form an acute angle with the top surface 332 of the wind indicator 308 such that the first fin 338 and the second fin 344 are angled away from one another. The first fin 338 has a first midplane, which forms an acute angle with the top surface, and the second fin 344 has a second midplane forming an acute angle with the top surface such that the first fin 338 and the second fin 344 are angled away from one another.

As shown in FIG. 18, the wind vane can comprise one or more supplemental directional elements 400 disposed along the vertical member.

The wind indicators described herein can further include colored/retroreflective stickers on the fins to provide improved visual measurement. Alternatively, or additionally, colored LEDs on the fins can be used to provide improved visual measurement.

In some embodiments, the apparatuses described herein can further include a free-rotating potentiometer providing for electronic measurement of wind direction. Alternatively, or additionally, one or more electromagnetic coils on the wind indicator and/or at the position where the wind indicator interfaces with the vertical member may provide for electronic measurement. An estimate of wind speed and gust frequency may also be provided in such embodiments wherein the device would include the necessary hardware structures for the same.

In one embodiment, the electronic information obtained by the electronic hardware embedded into the apparatus is wirelessly relayed to one or more remote devices. The data may be displayed on a mobile device to a remote user for consideration and analysis. The communication may be made in any appropriate manner including by Wi-Fi, Bluetooth, Bluetooth LE, Zigbee, or near-field communication.

A measurement of the tilt of the vertical member may be obtained through a potentiometer or an electromagnetic coil arrangement affixed on both the vertical and elongate members. Such an arrangement can output data on rotation and vessel lean.

In an embodiment, the apparatus includes a gimbal joint that is electronically controlled. In such an embodiment, each of the axes of rotation is in communication with a motor such that a shaft extending out from each motor is coaxially aligned with each controlled axis. An accelerometer disposed within the cap 128 or weight 270 reacts to dynamically changing positions of the cap 128 or weight 270 based on the rotation or displacement of the mounting substrate and the wind direction. The dynamic position of the cap 128 or weight 270 is then processed by at least one processor and the information is electronically relayed to each of the motors of the gimbal. The motors act in opposition of the displacement of the cap 128 or weight 270 such that the base of the upper portion and position of the wind indicator are dynamically adjusted to a true position. In such an embodiment, the sailing wind vane is in communication with at least one power source.

In one embodiment, the electronic information obtained within the gimbal mount is wirelessly relayed to one or more remote devices. The data may be displayed on a mobile device to a remote user for consideration and analysis. The communication may be made in any appropriate manner including by Wi-Fi, Bluetooth, Bluetooth LE, or near-field communication.

In one embodiment, the wind vane is coupled with an anemometer to measure the wind speed. The anemometer can be a cup-based anemometer. The anemometer can further record and transmit electronic information to the same electronic processor that the wind vane transmits electronic information to.

In some embodiments, the wind vane is coupled to a compass to identify the direction of the wind. In some embodiments, the compass is positioned on top of the rod end 118.

In some embodiments, the wind vane does not comprise an elongate member 204. In some embodiments, the vertical member 206 is configured to be a handle. In some embodiments, the weight 270 is embedded within the vertical member 206.

While the foregoing description and drawings represent preferred or exemplary embodiments of the present invention, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made without departing from the spirit of the invention. One skilled in the art will further appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims and equivalents thereof, and not limited to the foregoing description or embodiments. Rather, the appended claims should be construed broadly, to include other variants and embodiments of the invention, which may be made by those skilled in the art without departing from the scope and range of equivalents of the invention. All patents and published patent applications identified herein are incorporated herein by reference in their entireties.

What is claimed is:

1. A wind indicator comprising:
a bottom surface;
a top surface opposite the bottom surface
a first side and a second side extending from the bottom surface to the top surface;
a first fin extending from the top surface and having a forward portion and an aft portion; and
a second fin extending from the top surface and having a forward portion and an aft portion;
wherein a first distance between the respective aft portions of the first and second fins is greater than a second distance between the respective forward portions of the first and second fins such that the first and second fins converge toward one another at an acute angle.

2. The wind indicator of claim 1, wherein the first fin has a first midplane, the first midplane forming an acute angle with the top surface, and wherein the second fin has a second midplane forming an acute angle with the top surface such that the first fin and the second fin are angled away from one another.

3. The wind indicator of claim 1, wherein the first side and the second side converge at the same acute angle at which the first fin and the second fin converge.

4. The wind indicator of claim 3, wherein the first side is longer than the first fin and the second side is longer than the second fin.

5. The wind indicator of claim 1, further comprising a bore extending from the top surface to the bottom surface, the bore configured for receiving a shaft.

6. The wind indicator of claim 5, wherein the first fin and the second fin are disposed posterior of the bore.

7. An apparatus for detecting wind direction comprising:
an attachment member;
an elongated member extending outward from the attachment member;
a vertical member coupled to the elongated member; and
a wind indicator coupled to the vertical member, the wind indicator comprising:
a bottom surface;
a top surface opposite the bottom surface;
a first side and a second side extending from the bottom surface to the top surface;
a first fin extending from the top surface and having a forward portion and an aft portion; and
a second fin extending from the top surface and having a forward portion and an aft portion;
wherein a first distance between the respective aft portions of the first and second fins is greater than a second distance between the respective forward portions of the first and second fins such that the first and second fins converge toward one another at an acute angle.

8. The apparatus of claim 7, wherein the first fin and the second fin are positioned posterior to an apex of the wind indicator.

9. The apparatus of claim 7, wherein the vertical member and the elongated member are in communication with each other through a multi-axis joint.

10. The apparatus of claim 7, wherein the wind indicator rotates around an axis defined by the vertical member.

11. The apparatus of claim 7, further comprising one or more supplemental directional elements disposed along the vertical member.

12. The apparatus of claim 7, wherein the first fin has a first midplane, the first midplane forming an acute angle with the top surface, and wherein the second fin has a second midplane forming an acute angle with the top surface such that the first fin and the second fin are angled away from one another.

13. The apparatus of claim 7, wherein the first side and the second side converge at the same acute angle at which the first fin and the second fin converge.

14. The apparatus of claim 13, wherein the first side is longer than the first fin and the second side is longer than the second fin.

15. The apparatus of claim 7, wherein the wind indicator further comprises a bore extending from the top surface to the bottom surface, the bore configured for receiving a portion of the elongated member.

16. The apparatus of claim 15, wherein the first fin and the second fin are disposed posterior of the bore.

17. The apparatus of claim 7, further comprising a weight positioned at an end of the vertical member.

18. An apparatus for detecting wind direction comprising:
an attachment member;
an elongated member extending outward from the attachment member;
a vertical member coupled to the elongated member;
a first magnet coupled to the vertical member;
a wind indicator coupled to the vertical member such that the wind indicator can rotate about the vertical member and can translate along the vertical member; and
a second magnet coupled to the wind indicator;
wherein the first magnet is adjacent to the second magnet and the first magnet and the second magnet are arranged with like poles facing one another such that the wind indicator is at least partially supported by the magnetic force between the first magnet and the second magnet.

19. The apparatus of claim 18, further comprising one or more supplemental directional elements disposed along the vertical member.

20. The apparatus of claim 18, further comprising a weight positioned at an end of the vertical member.
